(19) United States
(12) Patent Application Publication
(10) Pub. No.: US 2005/0244568 A1
(43) Pub. Date: Nov. 3, 2005

(54) Artificial fruit

(75) Inventor: Cem Gokhan, Frankfurt am Main (DE)

Correspondence Address: PALMER & DODGE, LLP;KATHLEEN M. WILLIAMS, 111 HUNTINGTON AVENUE, BOSTON, MA, 02199, US

(73) Assignee: Sorsus GmbH

(21) Appl. No.: 11/102,313

(22) Filed: Apr. 8, 2005

Related U.S. Application Data
(63) Continuation-in-part of application No. PCT/EP05/02327, filed on Mar. 4, 2005.
(60) Provisional application No. 60/560,673, filed on Apr. 8, 2004.

(30) Foreign Application Priority Data
Mar. 4, 2004 (EP) EP04005189.8

(51) Int. Cl. A23L 1/236

(52) U.S. Cl. 426/658

(57) ABSTRACT

The present invention describes an edible product comprising a core composition comprising a sweetener and a shell or coating composition comprising at least one dietary fiber component, wherein the core composition is at least partially coated or encapsulated by the shell composition, a method of production of such an edible product, and its use.

This application is a Continuation-in-Part of international application No. PCT/EP05/XXXXX, filed Mar. 4, 2005 by inventor Cem Gökhan, and EP application No. XXXXX, filed Mar. 4, 2004 by inventor Cem Gökhan. This application also claims the priority of U.S. provisional patent application No. 60/560,673, filed Apr. 8, 2004. The entirety of each of these applications is incorporated herein by reference.

### FIELD OF THE INVENTION

The present invention relates to sugar substitutes and sweeteners for food.

### BACKGROUND OF THE INVENTION

Most common refined sugar is table sugar. Table sugar is sucrose, a disaccharide, consisting of glucose and fructose, purified in industrial scale e.g. from sugar beet or sugar cane.

Fast digesting Sugar creates an insulin/cortisol surge and an impact on blood sugar level; it may inhibit fat metabolism. It therefore may contribute to metabolic (e.g. diabetes) and systemic (e.g. cardiovascular) diseases and dietary disorders (e.g. obesity).

On the other hand, it is known that Sugar has hygiene, practical and socio-political advantages: Sugar is a purified source of energy (4 calories per gram.) with cheap unrestricted and standardized availability, anywhere around the world. Sugar is a very (more than 99%) purified industrial product and therefore does not contain pollutants or impurities which may be harmful to health. Sugar production methods are well established and it is very easy to pack, store and transport. Sugar, readily dissolving in water, is very practical to use especially in the formats in which it is presented (i.e. powder, crystals, cubes, candies etc.). The Sugar industry is huge, spread around the world, and supports many people in the fields of agriculture, industry, and sales. Sugar and the sugar industry may be the main income of some countries and is a major industry in most of the rest. Sugar, its use, its appearance and its taste is unquestionably known to all peoples of the world.

Some modified Sugar containing products and methods related thereto are known:

The fortification/nutrification/enrichment of Sugar with micronutrients such as vitamin A (Nutriview 96/1) have been done, where in some cases peanut oil was used as binder and an antioxidant agent was used to protect the oil, in Guatemala, under USAID in cooperation with Roche AG. The fortification of food containing sugar with vitamin, Iron or Zinc has been disclosed in U.S. Pat. No. 6,607,761; Calcium, too in U.S. Pat. No. 4,871,554.

Dietary fiber fortification of foods has also been disclosed in numerous references, such as U.S. Pat. Nos. 6,610,347 and 5,250,308 and 6,060,519.

Microencapsulation of sugar pellets with a fiber matrix containing a specific anti-fungal agent- to be administered as a pharmaceutical, has been disclosed in U.S. Pat. No. 6,663,901. Encapsulation of sugar with edible fat is disclosed in U.S. Pat. No. 3,976,794. Microencapsulation of vitamins and minerals with a matrix containing oligosaccharides, including fructooligosaccharides, has also been disclosed in U.S. Pat. No. 6,468,568. Encapsulation with beta-glucan enriched oats is also known from FI914491.

### SUMMARY OF THE INVENTION

Described herein are food sweetening products of manufacture comprising a core comprising a sweetener encapsulated in a shell comprising dietary fiber. The products described herein have the beneficial aspects of sugar, e.g., the sweetness of, e.g., sucrose, but the sweetener in the described products is not absorbed from the gut as efficiently as plain sucrose. It is surprising that the encapsulated product retains the sweetness of sugar while achieving the stated benefits, making it well suited as a substitute for sugar. Further, the described products also provide a very efficient delivery of soluble dietary fiber, due in part to the rapid exposure of sweetener-associated fiber when the sweetener dissolves.

### DESCRIPTION

Definitions

As used herein, the term “edible” refers to a product which is not toxic when ingested by a healthy individual.

As used herein, the term “sweetener” refers to an edible agent that tastes sweet to a person. As used herein, sweet taste or sweetness is measured on a relative scale versus the sweetness of common table sugar, sucrose. There are two common sweetness scales—one sets the sweetness of sucrose equal to 1 and rates compounds on a fold difference relative to the sweetness of sucrose. On this scale, for example, saccharin is 300× as sweet as sucrose, cyclamate is 30× as sweet, aspartame is 180× as sweet, acesulfame is 200× as sweet, and sucralose is 600× as sweet. The other scale sets the sweetness of sucrose at 100. On this scale, sucrose rates 100, fructose rates 140, high fructose corn syrup rates 120-160, glucose rates 70-80, galactose rates 35, maltose rates 30-50, and lactose rates 20. As used herein, a compound is “sweet” if it is at least as sweet as lactose, on either scale. The term “sweetener” is intended to encompass natural sugars that are sweet, including, for example, sucrose, fructose, corn syrup, glucose, galactose, maltose, and lactose, as well as artificial sweeteners including, for example, sucralose, acesulfame, cyclamate, aspartame, and saccharin. Sweeteners as described herein are preferably at least as soluble as sucrose in water.

As used herein, the term “artificial sweetener” refers to a sweetener that is not a naturally-occurring sugar.

In one aspect, the edible product described herein can have any of a number of shapes and sizes. For example, product can be approximately the size of a sugar cube, with a shell comprising fiber. Shape and exact size are unimportant, although cube shapes are well known to the average consumer and likely to be readily accepted. Towards the smaller end of the scale, the product can comprise individual particles comprising a sweetener-containing core with a shell comprising fiber, in which individual particles can range from, for example, several millimeters, e.g., 5 mm, 4 mm, 3 mm, 2 mm, etc., down to, for example, a fine powder of such particles of about 0.01 mm to about 1 mm. The individual particles can have any shape, e.g., approximately cubic, approximately spherical, or any number of less regular shapes.

Further, smaller products as described herein can be joined together to form larger aggregates, which can be shaped into, e.g., cubes, in similar to the way everyday sugar cubes are made up of plain granular sucrose.

As used herein, the term “core comprising a sweetener” means that the core of the described particles comprises at least 5% sweetener by weight, preferably at least 30%, 50%, 70%, 80%, 90%, 95% or more, up to and including, for example, 99% to 100% sweetener by weight.

As used herein, the term “encapsulated” means that a core comprising a sweetener as defined herein is in physical communication on at least its outer surface with the shell comprising the dietary fiber. Ideally, the core is surrounded by a thin covering of shell material; however, the term “encapsulated” as used herein also encompasses the situation in which the shell material covers only a portion of the surface (i.e., at least 4% of the surface, preferably at least 20%, 30%, 40%, 50%, 60%, 70%, 80%, 90% or more, up to and including 100% of the outer surface of the core) as in a matrix or lattice of fiber material in communication with the outside of the core. The term does not exclude the possibility that shell material can be surrounded by core material, i.e., products can have regions in which the fiber material penetrates the core, yet still be considered “encapsulated” as long as there is also sufficient fiber present communicating with the outer surface of the core. While the presence of fiber on the surface of the core is ideally an even distribution over the surface, the at least 4% presence on the surface need not be evenly distributed, as long as at least 4% of the outer surface of the core is in communication with the shell.

As used herein, the term “dietary fiber” refers to an edible polymer material which is resistant to digestion by the secretions of the human gastrointestinal tract. Dietary fiber is preferably water soluble or water dispersible, and includes, but is not limited to celluloses, hemicelluloses, gums, pentosans, glucans, including beta glucan, mucilages and pectin.

As used herein, a core that “consists essentially of” sucrose or a sweetener in a particular form can comprise other entities only to the extent that they do not interfere significantly with the gelling properties of the fiber component of the product, or, to the extent that they do not interfere significantly with the association of the fiber with the core. By “significantly” in this context is meant at least a 1-fold difference, e.g., in terms of time other unit.

As used herein, the term “refined sucrose” refers to the sucrose form commonly known as table sugar.

As used herein, a “portion of the sucrose normally found” in a food refers to at least 1% of the sucrose present when a given food is produced without sweetener substitution, but can be higher, e.g., 5%, 10%, 20%, 30%, 40%, 50%, 60%, 70%, 80%, 90% or even essentially all of the sucrose or 100%.

As used herein, the term “chemical modification of a carbohydrate” refers to a process by which a carbohydrate based polymer is formed to generate a dietary fiber.

Reduced absorption of sugar in sweetener products as described herein can be measured in terms of lower glycemic index, i.e., the extent to which blood sugar is increased upon ingestion. A “reduced” glycemic index is a glycemic index value that is at least 5% lower after ingestion of an equivalently sweet amount of sweetener in a product as described herein relative to the index of a given amount of sucrose when ingested as refined sucrose. The reduction in glycemic index is preferably greater, e.g., 10%, 20%, 30%, 40%, 50%, 60%, 70%, 80%, 90% or more, relative to refined sucrose.

### DETAILED DESCRIPTION

Described herein are food sweetening products of manufacture that ameliorates or eradicate certain health disadvantages of Sugar, without losing the aforementioned advantages of Sugar. The products described herein provide further sole or synergetic advantages due to its composition and structure, with organoleptic and physical properties equal or superior to Sugar.

The products described herein can preferably be produced from natural raw materials by physical and mechanical means with no or minimal need for synthetic alteration or manipulation. The compositions can be designed and customized according to raw material cost/availability and consumer needs, and they are easy to produce.

According to one aspect, the present invention therefore concerns an edible product, which may be considered as a kind of “artificial micro-fruit”, wherein a sweetener-containing core composition is at least partially coated or surrounded by a shell composition comprising at least one fiber component or polymer, preferably at least one dietary fiber component.

The products described herein allow one to combine the advantages of refined sugar as set out above with the advantages of a “build-up” of an artificial micro-fruit with a core and a shell. The edible product, in particular but not necessarily in its shell composition, can comprise additional components which may also be present in the original source of sweetener, the raw or dried fruits or vegetables. Such additional components include, for example, minerals, proteins, enzymes (or enzyme inhibitors), all types of vitamins (including antioxidant agents) or vitamin precursors, sugar alcohols (such as sorbitol, xylitol, mannitol, etc.), sugars in diversity (i.e. monosaccharides (such as glucose, fructose, galactose, arabinose, xylose, etc.), disaccharides (such as sucrose, maltose etc.), polysaccharides - including water insoluble and soluble fibers (such as cellulose, starch, pectin, gums, etc.) and/or natural or artificial sweeteners.

The edible product described herein (hereafter referred to also as ‘Product’, i.e. product of the invention) preferably is an artificial fruit, and has a core and shell structure. More than one core and/or more than one shell can be present. The core(s) can have any regular or irregular shape and size. Preferred embodiments often include approximately spherical cores, e.g. sucrose crystals. Particularly preferred are, for example, sucrose crystals as commonly available as table sugar, i.e. with crystal diameters of between about 0.1 and 10 mm, or larger aggregates or shaped articles of sucrose, e.g. cube sugar, but also powder.

According to a preferred embodiment of the present invention, the core composition comprises more than 50% by weight, more than 70% by weight, more than 90% by weight, preferably more than 95 wt-% or even more of sweetener. According to a particularly preferred embodiment, the core composition essentially (in particular more than 98 wt-% or even more than 99 wt-%) or completely consists of sweetener. The sweetener is preferably in solid particulate form, like crystalline sweetener. According to a particularly preferred embodiment of the present invention, the sweetener is present in the form of refined crystalline sugar, such as sucrose or table sugar, in particular purified white crystalline sugar.

Alternatively, according to another embodiment of the present invention, the core is made of or comprises less refined sugar or sweetener, in particular sugar with treacle or molasses. Also, a mixture of sugar and treacle or molasses can be advantageously used. The meaning of treacle or molasses is known to the skilled person. In brief, Treacle (or Fancy Molasses as it is popularly called), is a viscous, rich, dark brown color, concentrated sugarcane juice (syrup), manufactured by concentrating the fully matured tropical sugarcane stalks. Typical total solids are about 70 to 85%, the pH is typically between 4.5 to 5.5. The advantage of using such less-refined sugar in the core is that less or even no additional components must be added to the dietary fiber containing shell, and the beneficial components in the less refined sugar (e.g. vitamins, probiotics etc.)are well embedded in the core-shell structure and at the same time readily available.

According to a preferred embodiment of the present invention the core is essentially comprised of sweetener or sugar and is encapsulated in or surrounded at least partially with a solid shell.

The shell comprises preferably at least one dietary fiber or polymer, preferably a water-soluble one. Preferably, at least one or more types of the dietary fibers are selected from the group of celluloses, hemicelluloses, gums, pentosans, glucans, including beta-glucan, mucilages and pectin, particularly water-soluble or water-dispersible dietary fibers, in particular beta-glucan and/or pectin. According to one embodiment of the present invention, synthetic and/or natural fibers (polysaccharides) can be used. This includes also the expanding field of so called modified starches or modified polysaccharides, e.g. starches or other polysaccharides which have been chemically modified to provide beneficial properties.

Particularly advantageous products are obtained if it further comprises an edible antioxidant agent or a plant extract with an antioxidant capacity, from at least a single plant source, such as, but not limited to vegetables, legumes, fruits, grain products, nuts and leaves. According to a preferred embodiment of the present invention, the Product's total Oxygen Radical Absorption Capacity (Wang et al 1996; Cao et al 1996; Ou et al 2001) is not less then 1 ORAC units=1 micromol Trolox or gallic acid equivalent/gr.

Further preferred products further comprise at least one water soluble vitamin, particularly B-complex vitamins. Preferably, the Product comprises at least one of the following: Thiamine or equivalent not less than 0.02 mg/1000 KJoule, and Riboflavin or equivalent not less than 0.03 mg/1000 KJoule, Niacin or equivalent not less than 0.04 mg/1000 KJoule, and Calcium not less than 5 mg/g of the total dietary fiber content.

In one embodiment, the edible antioxidant agent is a carotenoid or a phenolic compound or an anthocyanin or a mineral or an (other) flavonoid or an aminoacid or a lipoic acid.

The product described herein can comprise additional components. These additional components can be, for example, insoluble dietary fibers (e.g. cellulose and some hemicelluloses), phytonutrients, minerals, amino acids, enzymes, all sorts of vitamins and vitamin precursors (including antioxidant agents), sugar alcohols (e.g. sorbitol, mannitol) and sugars in diversity (monosaccharides (e.g. glucose, fructose, galactose, arabinose), disaccharides (e.g. sucrose, maltose ), polysaccharides, and compositions such as maltodextrin).

In one embodiment, the product described has total dietary fiber content not less than 1% of its sugar content, has a caloric value lower than 4 calories per gram of its solid content and/or has a total lipid content lesser than weight/weight 2% of its total solid content.

Just as in natural fruits, the edible product of the present invention has several advantages:

Thus, the Products allow combination of the aforementioned advantages of Sugar with the advantages of dietary fibers. Moreover, in some embodiments, the Products are further enhanced with the advantages of antioxidants and with the advantages of B-complex vitamins which have been found to act synergistically in the “structure” of the Product as an artificial micro-fruit (or fruit) with core-shell structure. Preferably, the advantages of additional components in plant extracts can be added.

The Products that comprise sugar, e.g. sucrose, have the advantage of ameliorating or avoiding the aforementioned health disadvantages of Sugar. Thus, even though it dissolves and tastes like sugar, the Products are found to have lesser Glycemic Index than the corresponding amount of pure refined sucrose. This converts to a conclusion that: Product is not digested as rapidly as pure refined sugar and therefore does not cause the same insulin/cortisol surge (as Sugar does).

It was also unexpectedly observed that the Products with their core-shell composition can have a higher efficiency of Glycaemic Index lowering effect. Sweeteners as described herein (including, but not limited to sucrose or other granulated/powdered carbohydrate core) are a convenient carrier for the fiber, which allows it to gel (hydrate) very rapidly in water. It is believed that the reason why the gelling is instant is that it exists as a thin film on the surface of the granule. The full functionality (gelling) of the fiber is therefore realised in seconds (essentially instant) rather than the minutes or hours powdered aggregates normally require to reach maximum viscosity. The invention also avoids the issue of clumping and removes the need for high shear mixing to disperse the gelling agent (fiber). As the gelling is instant, the full functionality (e.g. dissolving, taste) of the sweetener or sugar is also realized without delay and the product looks and tastes like sugar. Therefore, one of the surprising advantages of the present invention can also be observed in the full functionality of the fiber (shell) and sweetener to be realised instantly without delay. Thus, although it is encapsulated, the Product still looks, tastes and performs like sugar, which is surprising. This indicates that the core-shell structure is a more efficient structure of making use of the Glycaemic Index lowering effect of dietary fibers. This converts into a conclusion that: As sweetener or sugar is present with at least a soluble dietary fiber, preferably beta-glucan, in a core-shell structure, where sweetener or sugar is in the immediate vicinity of, and surrounded by, the instantly-gelling dietary fiber, the digestion of the sweetener core of the Product is more efficiently inhibited by the said dietary fiber as the digestion of sweeteners such as sugar is related to the viscosity of the digestive medium in which it is present. Therefore, according to a preferred embodiment of the present invention, the fiber is in direct contact with the sweetener in the core, and preferably the shell comprising the (dietary) fiber is very thin, in particular below 50 μm, preferably below 10 μm, more preferred below 5 μm, even more preferred below 1 μm.

The dietary fibers reduce the absorption of sugars present in a sweetener, B-complex vitamins increase the conversion of sugars to energy in vivo, and antioxidants reduce the free radical forming and antioxidant-reducing effects of sugars such as sucrose. Therefore, according to one embodiment these agents can be present and they can synergistically ameliorate the health disadvantages previously mentioned.

The above components of the Product of the invention, including the optional ones, are known to the person skilled in the art as such, however, they can be further illustrated as follows.

Dietary fibers are indigestible, sometimes fermentable polysaccharides, most commonly classified according to their water solubility. Soluble fibers are e.g. some hemicelluloses, variety of gums, pentosans, glucans, including beta-glucan, mucilages and pectin. Insoluble dietary fibers are e.g. cellulose and some hemicelluloses. The primary health advantages of both type of fibers and other components are known:

Found in abundance in plants, especially in grain products and psyllium husk, soluble dietary fibers form a gel in the gastrointestinal tract, delaying the digestion of carbohydrates. They soften the faeces, ease and regulate the gastrointestinal passage. They bind to organic molecules, such as bile acids, they, especially beta-glucan (from oat products and psyllium husk), are cited for lowering the total and LDL blood cholesterol and being preventive for coronary heart disease and cancer of the gastrointestinal tract. Health benefits of soluble dietary fibers are also reported for diseases of pancreas including diabetes. There are also citations on immune system boosting effect of beta-glucan.

Insoluble dietary fibers also soften and add mass to faeces, inhibit the absorption of fats, and speed the gastrointestinal passage. Insoluble fibers are associated with gastrointestinal tract cleaning and prevention of colon cancer.

Unstable radicals, such as peroxyl and hydroxyl, characterized with an atom with an unpaired electron in the orbit around the nucleus, are called free radicals, and have a known damaging oxidation effects. Substances which can neutralize free radicals are termed antioxidants. Antioxidants are numerous and their list is growing every day. Antioxidants have known anti-carcinogenic, anti-aging and life quality enhancing effects. Glucose is known to increase free radicals and decrease the antioxidant capacity in blood. Plants, in particular fruits and vegetables, are known to be the richest sources of natural antioxidants.

B-complex vitamins include, for example: Vitamin B1 (Thiamine), vitamin B2 (Riboflavin), vitamin B3 (Niacin), vitamin B5 (Pantothenic acid), vitamin H (Biotin), vitamin B6 (Pyridoxine), vitamin B9 (Folate), vitamin B12 (Cobalamin). In this list, especially vitamins listed from Vitamin B1 (Thiamin) through to Vitamin B6 (Pyrodoxine) are involved in Energy Metabolism and in particular carbohydrate metabolism. PABA, inositol and choline are often included in this group.

Vitamins are essential organic compounds that the body needs in small quantities for normal functioning. In addition to being essential for growth and health, some vitamins also have an antioxidant activity. Many compounds have been classified as vitamins. Vitamins A, D, E, and K, the four fat-soluble vitamins, may accumulate in the body. Vitamin C and the eight B vitamins—biotin, folate, niacin, pantothenic acid, riboflavin, thiamin, vitamin B6, and vitamin B12—dissolve in water, so excess amounts are excreted. Vitamin precursors are inactive forms of vitamins to be activated after ingestion. e.g. carotenes, flavin complexes, folates.

Phytonutrients are certain organic components of plants, and these components are thought to promote human health. Fruits, vegetables, legumes, grain products, nuts and leaves are rich sources of phytonutrients. The phytonutrients are also referred to as “phytochemicals.” Some of the common classes of phytonutrients include: Carotenoids, Flavonoids (Polyphenols) including Isoflavones, Inositol Phosphates (Phytates), Lignans (Phytoestrogens), Isothiocyanates and Indoles, Phenols, Saponins, Sulfides and Thiols, Terpenes. Phytonutrients are suggested to protect and enhance human health probably by means of serving as antioxidants, enhancing immune response, enhancing cell-to-cell communication, altering estrogen metabolism, converting to vitamin A (beta-carotene is metabolized to vitamin A), causing cancer cells to die (apoptosis), repairing DNA damage caused by smoking and other toxic exposures and detoxifying carcinogens through the activation of the cytochrome P450 and Phase II enzyme systems.

Amino acids are the building blocks of proteins and there are known amino acids which the human body cannot synthesize and therefore should be taken up by diet, most of which are found in high levels in plants, especially in legumes.

Enzymes have essential use in digestion. Natural extracts contain useful enzymes which may be beneficial in many ways. e.g. alpha amylase, a major enzyme in digestion, of sucrose or other disaccharides, or its inhibitor can be extracted from plant sources.

Sugar alcohols (e.g. sorbitol) are sweet and low in calories, advised in a diabetic diet and widely used as low calorie sweeteners. Sugar alcohols are digested less and slower than sugars. Sugar alcohols don't cause dental decay and may inhibit the pathogens of the mouth flora.

Minerals that can be present in or added to products as described herein are classified in two groups. 1-Macro minerals: Calcium and Phosphorus are essential for skeletal system. Sodium, Potassium and Chlorine are essential for hemostasis. 2-Micro (or trace) minerals: Magnesium, Manganese, Zinc, Iron, Copper, Iodine and Selenium are essential parts of enzymes, hormones or enzyme activators. Chromium is important for metabolism.

Also, the Product has synergetic health advantages of the above essential and optional components of its composition:

Product composition particularly with the use of diversity of ingredients mimics the composition of plants, particularly of fruits. The composition of plants, particularly the composition of fruits, have synergetic effects which are advantageous for health. To name a few, human nutritional and cell culture studies link fruit and vegetable consumption to numerous health benefits, such as, to a decreased risk of stroke—both hemorrhagic and ischemic stroke (Gillman et al. Journal of the American Medical Association. 1995;273;1113); to about a 46% decrease in risk of heart disease relative to men who ranked in the lowest quartile; to about a 70% lower risk of cancer than did their counterparts in the lowest quintile (Gaziano et al. Annals of Epidemiology 1995;5:255 and Colditz et al. American Journal of Clinical Nutrition 1985;41:32); to a decreased risk of prostate cancer (Giovannucci et al. Journal of the National Cancer Institute 1995;87:1767); to a 46% decrease in risk of age-related macular degeneration compared to those in the lowest quintile who consumed vegetables less than once per month (Seddon et al. Journal of the American Medical Association. 1994;272:1413). Also, the association between fruit consumption and lowered cardiovascular hearth disease and lowered risk of cancer has been cited by FDA. Plant diets are widely known as a remedy to a number of diseases, including obesity.

Furthermore, the Products described herein have the advantage of having organoleptic and physical properties equal or superior to Sugar. Thus, the Products can be produced from an abundant number of natural sources. According to one possible embodiment of the invention, a neutral (tasteless, odourless) natural extract can be choosen, in order to keep the organoleptic properties of the core content, when it comprises sucrose or other sugar unaltered or alternatively the natural extract's taste and odour can be neutralized or alternatively a natural extract (such as apricot extract) or flavour components with a specific aroma can be used in the composition of Extract to improve the organoleptic properties of the core content sweetener. The physical properties (e.g. flowability, solubility, texture and appearance as packed) of Products described herein can also be kept similar to Sugar for appeal to the consumer.

The Products also have the advantage of not losing the aforementioned known advantages of Sugar and have numerous industrial advantages. Thus, advantageously, the Products can easily be produced from natural extract(s) by mechanical/physical means with processes known in the art.

Ingredients can be obtained from commercial sources, synthetic sources and/or from natural sources, in particular from plant sources, e.g. vegetables, legumes, fruits, grain products, nuts and leaves by mechanical/physical means with processes for obtaining the ingredients or Extract known in the art.

Advantageously, all the aforementioned components (e.g. dietary fibers, phytonutrients, minerals, amino acids, enzymes and sugar alcohols) do exist and coexist in diverse combinations in different plants, thus eliminating the necessity for industrial steps for purification/isolation of each component separately and then adding each one by one to the final composition. Products and production design therefore can be tailored according to raw material cost/availability and desired end-product specifications, which will vary according to the location of the production plant.

According to one embodiment of the invention, the Product, as discussed in detail later in this specification, has only 2 easy steps of production, i.e. preparation of Extract and encapsulation. The automation of production and minimizing environmental impact is easily achieveable. Advantageously, the cost of raw materials is a fraction of refined sucrose. Oat ( a good source of beta-glucan) for example costs ca. ⅛th as much as refined sucrose. Advantageously, the Product can be produced from by-products of other industries including the sugar industry and beverage industry. Advantageously, the production of Product can easily be integrated to existing production lines of many industries including the sugar industry and starch industry. Advantageously, all by-products of the production (such as starch) can be commercialised, in most cases, with a higher value than the cost of raw materials.

Furthermore, the Product has structural ‘solid core in solid shell’ advantages:

The structure of the artificial fruit with a core and a shell, comprising soluble dietary fibers, also presents the advantage of a solid, stable carrier matrix, enabling the addition and preservation of optional natural components (e.g. amino acids, enzymes, minerals or antioxidants) which would be difficult to attach otherwise to sugar or which would otherwise be difficult to dose or stabilize. In fact, in nature, the said additional components, in diverse combination, coexist with each other within plant extract(s), which can be utilized within this invention, thus eliminating the need for nutrification/fortification.

Advantageously, the shell can act as intermediate buffer in release of, especially, fragile molecules such as amino acids and enzymes where controlled release may be necessary.

Advantageously, the shell, having a natural composition therefore superiorly stable by nature and by being dry therefore organic reactions being at least ceased, provides a dry protective matrix which improves the mechanical and chemical stability of Product and components, which otherwise would be or would become unstable for example with an oxidative reaction. A further advantage of the stable structure is its possible use as a vector for prophylactic and therapeutic agents, which would otherwise be difficult to dose, immobilize and stabilize over a naked Sugar surface.

Advantageously, by using colored substances, such as carotenoids, and aromatic substances and suitable tooling, Product can be produced in any form and in any colour and in any aroma or odour.

According to one particular embodiment of the invention, the product of the invention does not contain a drug or medicament. According to a further embodiment, the shell does contain less than 90 wt-%, preferably less than 80 wt-%, more preferably less than 70 wt-%, even more preferably less than 60 wt-% and in particular less than 50 wt-% of pectin. According to a further embodiment, the shell does contain less than 90 wt-%, preferably less than 80 wt-%, more preferably less than 70 wt-%, even more preferably less than 60 wt-% and in particular less than 50 wt-% of erythritol. Such amounts of erythritol may pose problems with retained moisture and humidity of the shell.

Advantageously, the shell can be composed to carry indicators (e.g. pH indicator) to indicate the condition of the product or its components, e.g. regarding pH-value, redox status, degradation products etc.

Another advantage of Product is to ameliorate or avoid known problems and disadvantages of natural fruits. Thus, it is known that fruits have disadvantages:

Fruits are not produced but grown, and therefore are more condition-dependant and less standardized to obtain compared to industrial products. Fruits are also difficult to pack, store and transport. Fruits have short shelf life (e.g. few days) in room conditions. Fruits are impractical to use (e.g. you cannot drop an apricot into your coffee or cannot mix an orange with flour and bake a cake). Some fruits may contain toxins, such as lectins. Fruits may be expensive. Fruits are not standardized.

The following paragraph discloses further preferred embodiments of the present invention which, if combined subsequently, have been found to give particularly advantageous products:

Edible product comprising a solid shell encapsulating at least partially, preferably substantially completely a core comprising a sweetener as described herein. The said solid shell comprises at least one dietary fiber composition. The said product can comprise an edible antioxidant agent or a plant extract with an antioxidant capacity, from at least a single plant source, such as but not limited to vegetables, legumes, fruits, grain products, nuts and leaves. In one embodiment, the said product's total Oxygen Radical Absorption Capacity (Wang et al 1996; Cao et al 1996; Ou et al 2001) is not less then 1 ORAC units=1 micromol Trolox or gallic acid equivalent/gr., preferably not less then 2.6 ORAC units=2.6 micromol Trolox or gallic acid equivalent/gr. In another embodiment, the said product comprises at least Thiamine or equivalent not less then 0.02 mg/1000 KJoule and Riboflavin or equivalent not less then 0.03 mg/1000 KJoule and Niacin or equivalent not less than 0.04 mg/1000 KJoule and Calcium not less then 5 m /g of the total dietary fiber content. In one embodiment, the product has a total dietary fiber content of not less than 1% of its sugar content and a caloric value lower than 4 calories per gram of its solid content and a total lipid content less than 2% weight/weight of its total solid content.

According to another embodiment, the dietary fiber composition comprises at least one or more types selected from the group of hemicelluloses, gums, pentosans, glucans, including beta-glucan, mucilages and pectin.

According to another embodiment, the core composition comprises or essentially consists of sweetener in solid state, either in crystalline form or granular form or particulate form or dried syrup form.

According to another embodiment, the core composition comprises or essentially consists of refined sucrose.

According to another embodiment, the core composition comprises or essentially consists of unrefined or semi-refined or molasses related sucrose in solid form.

According to another embodiment, the core composition comprises or essentially consists of sucrose or other sugar or sweetener obtained by enzymatic reactions or synthetically.

According to another embodiment, the core composition comprises or essentially consists of a single sweetener crystal or a single sweetener granule or a single sweetener particle.

According to another embodiment, the core composition comprises or essentially consists of more than one of sweetener crystal or granule or particle, attached or adjacent (glued or un-glued) to each other or to the shell.

According to another embodiment, the core composition comprises or essentially consists of sweetener in liquid or semi-solid state, either as a gel or in a saturated solution or in an unsaturated solution.

According to another embodiment, at least one dietary fiber is obtained from natural sources such as plant, bacteria, yeast, fungi, animal.

According to another embodiment, at least one of the dietary fiber types is artificially produced or obtained from genetically manipulated living sources or by chemical manipulation of carbohydrates.

According to another embodiment, at least one of the dietary fiber types is obtained from multiple sources.

According to another embodiment, a plant extract (“Extract”) is used for the shell composition and the said plant extract comprises also at least part of the dietary fibers and/or Thiamine and/or Riboflavin and/or Niacin and/or Calcium.

According to another embodiment, the product composition further comprises at least one or more additional components selected from the group of insoluble dietary fibers (e.g. cellulose and some hemicelluloses), phytonutrients, minerals, amino acids, enzymes, all sorts of vitamins and vitamin precursors (including antioxidant agents), sugar alcohols (e.g. sorbitol, mannitol) and sugars in diversity (monosaccharides (e.g. glucose, fructose, galactose, arabinose), disaccharides (e.g. sucrose, maltose ) and polysaccharides).

According to another embodiment, the product composition further comprises at least one or more additional components selected from the group of colour indicators, pH indicators, colouring agents and aromatic agents.

According to another embodiment, the product composition further comprises at least one or more additional components selected from the group of pharmaceutical and/or health improvement agents and/or nutrification/fortification agents.

According to another embodiment, the soluble dietary fiber component, particularly beta-glucan, is derived from either oat products, barley or psyllium husk.

According to another embodiment, the antioxidant agent is a carotenoid or a phenolic compound or an anthocyanin or a mineral or an other flavonoid or an amino acid or a lipoic acid.

According to another embodiment, the product composition further comprises at least one or more additional vitamins selected from the group of vitamins: Vitamins A, D, E, K, C, B6, B12, biotin, folate and pantothenic acid or their precursors and/or PABA, inositol and choline.

According to another embodiment, the product composition further comprises at least one or more additional minerals selected from the group of minerals: Phosphorus, Sodium, Potassium, Chlorine, Magnesium, Manganese, Zinc, Iron, Copper, Iodine, Selenium and/or Chromium.

According to another embodiment, the sugar alcohol is sorbitol, in particular from prune.

According to another embodiment, the phytonutrients are selected from one or more of the following minerals: Carotenoids, Flavonoids (Polyphenols) including Isoflavones, Inositol Phosphates (Phytates), Lignans (Phytoestrogens), Isothiocyanates and Indoles, Phenols, Saponins, Sulfides and Thiols, Terpenes.

According to another embodiment, the core composition is encapsulated by the shell composition at least partially or the core composition is being packed into an edible case comprising the shell composition.

According to another embodiment, the core and the shell are attached to each other in such a way that neither core nor shell can move independent from each other.

According to another embodiment, the core and the shell are not attached to each other in such a way that the core and the shell can move independent from each other.

According to another embodiment, the shell composition is applied to the core composition by wet or dry coating of the shell composition onto the wet or dry core composition.

According to another embodiment, at least one essential component of the product composition other then sweetener is obtained from by-products of other industries, such as beverage and food industries, e.g. beer industry or starch industry.

According to another embodiment, the product composition has a reduced content of starches and lipids, in particular saturated lipids and substances harmful to health (e.g. intolarable substances (e.g. gluten), toxins (e.g. lectins)) or to product's organoleptic or physical or chemical qualities.

According to another embodiment, the product can be in any practical size, shape, colour, odour, texture, depending on the specific use envisaged.

Methods of making the products described herein are described below and in the accompanying Example.

There are a number of ways in which products described herein can be produced. For example, the process can comprise the following steps:

a) providing a core composition comprising a sweetener, preferably refined sucrose in crystalline form

b) contacting the core composition with the shell composition in order to apply the shell composition onto the core composition so that the core composition is at least partially surrounded by the shell composition or, alternatively to b),

c) packaging the core composition in a case or bag of the shell composition in order to obtain a product wherein the core composition is packaged in an edible package material.

It is particularly advantageous to use a shell composition which comprises an extract (herein “Extract”) which is preferably derived from aqueous extraction of a natural source, like a fruit, plant, animal or microbiological source. Such an aqueous extract can preferably be obtained by obtaining the water soluble components of a natural source, e.g. after grinding, milling, mixing with water, preferably at less than 100° C., and separation from the water-insoluble fraction, e.g. by filtration or centrifugation or the like. The extract can be further fractionated or components as specified above can be added.

Thus, according to a preferred embodiment, sugar particles (e.g., sucrose, but similar processes can be applied to other sugars or sweeteners) are encapsulated with a soluble fiber containing extract.

Preferably, the shell composition is wet-coated over a dry core composition. Methods for applying or coating the shell composition onto/around the core composition are known to the expert in the art. Conventional mixing or coating equipment can be used.

The edible product can be considered as a re-naturalized sugar. In other words, it is an artificial micro-fruit. It eliminates all the disadvantages of both refined sugar and natural fruits while combining the advantages of both.

The process of is simple, cheap and dietary safe.

The embodiment wherein the core composition is packaged in a case or bag of the shell composition allows a choice between using only a refined sugar (by opening and discarding the package material) or using re-naturalized sugar (by dropping the unopened package into e.g. a drink like tea or coffee). By combining refined sugar, soluble fibers and, optionally, additional components like vitamins, using the method described herein, a re-naturalizing of refined sugar can be achieved without diminishing the sensitive properties of table sugar.

A re-naturalized sugar will exhibit all the—combined—advantages of both refined sugars and fruits without compromising physical properties, taste and cost of the table sugar significantly. Moreover, all or most disadvantages will be ameliorated or eliminated.

Also surprising and novel is the method of production involving encapsulation of a wet or dry fiber component containing optionally sugar alcohol and vitamins onto dry sweetener crystals, without losing physical properties of sugar or clamping or dissolving.

A further aspect of the present invention is directed to the use of an edible product as defined herein, in particular an edible product comprising a core composition comprising sweetener or sugar and a shell or coating composition comprising at least one soluble fiber or polymer, wherein the core composition is at least partially coated or encapsulated by the shell composition. A preferred use is as a replacement or alternative product to (conventional) sucrose, in particular crystalline sucrose like table sugar. A preferred use is as an additive or ingredient to solid or liquid food, like coffee, tea or other drinks, bread, sweets, cold and warm meals, as a sweetener or the like. Thus, a preferred aspect of the invention is also to a method of using the edible product of the invention in an edible composition or recipe as a replacement for (conventional) sucrose, in particular crystalline sucrose like table sugar. The preferred edible composition can be a solid or liquid food, like coffee, tea or other drinks, bread, sweets, cold and warm meals, in particular as a sweetener or the like.

The invention is now further illustrated by the following non-limiting example.

### EXAMPLE

The production of the Product comprises two main processes: 1-extraction, 2-microencapsulation or encapsulation. Extraction has two main types: extraction of soluble fibers and extraction of phytonutrients and water-soluble plant ingredients.

Extraction of Soluble Fibers:

What is to be extracted from which natural source is a decision to be made according to the desired specifications of the final product. Given here is a general extraction procedure applicable to all grain products and legumes or to any plant source where the source is rich in both soluble fibers and starch. In cases where starch content is not a concern, the starch extraction steps can be omitted.
Full oat grain is ground to a flour.
100 g of said flour is placed in a homogenizer.
1000 cc of ice-water mix at 2° C. is added to the homogenizer.

Mixture is homogenized for 10 minutes at 480 rpm, maintained at 2-4° C.

Immediately after homogenization, the homogenate is filtered through a membrane filter under pressurized continuous spray water at 4° C., for approximately 10 minutes.
Filtrate is then suspended in 500 cc of water at 40° C. for 5 minutes, with gentle stirring.
The suspension is then centrifuged for 2 minutes, and the supernatant liquid is used to encapsulate table sugar.
Encapsulation is carried out in a heated pan by constant mixing of crystalline sweetener, e.g., sucrose, with the supernatant liquid (extract) under blown warm dry air.

Extraction of Phytonutrients and Water Soluble Plant Ingredients:

What is to be extracted from which natural source is a decision to be made according to the desired specifications of the final product. Given here is a general extraction procedure applicable to all plants, raw or dry or processed.
Prunes, deseeded, are rinsed in cold water and wiped dry to remove impurities and homogenized into a paste.
20 g of said paste was placed in a homogenizer.
200 cc of water at RT are added to homogenizer.
Homogenize for 10 minutes in 2400+ rpm at RT.
The slurry is filtered through a sieve under mild pressure.
The filtrate is further processed as diet ingredient.
The filtered liquid is evaporated in RT under vacuum to 50 cc and is immediately homogenized with dietary fiber extract at RT.

Different extracts obtained with the above process will be compatible with each other. Thus, they can be mixed in pre-determined ratio, using a homogenizer, e.g. in 3,600 rpm and in RT for 4 minutes.

Final ratios should be adjusted according to desired end product specifications.

The final plant extracts prepared as above can be immediately used for encapsulation.

The Encapsulation:

At least three methods can be used. Known apparatus and methods familiar to the skilled person can be used. Encapsulation is exemplified below with sucrose, but can be readily applied to other sweeteners.

Method 1:

The aforementioned 120 cc final extract is further evaporated to 60 cc under vacuum and mixed to 200 gr of commercially available crystalline sucrose either in a continuous mixer under vacuum until dry again or placed in molds and dried to harden in different shapes such as cubes.

Method 2:

The aforementioned 120 cc final extract is sprayed to 200 gr of commercially available crystalline sucrose using dry, pressurized air in 35° C. The sugar is constantly circulated through the spray zone and dried with 35° C dry air in between each pass.

This method can also be used for pre-formed Sugars such as cube sugar.

Method 3:

Alternatively the final extract can be sprayed and dried in sheet format, to be used as an edible packing film, in this case presence of sugar alcohols in concentrations above 0.5% will plasticize the film and increase the tensile strength.

1. A food sweetening product of manufacture comprising a core comprising a sweetener encapsulated in a shell comprising dietary fiber.

2. The product of claim 1 wherein the total dietary fiber content of said product is at least 1% by weight relative to the sweetener content.

3. The product of claim 1 wherein said dietary fiber comprises a fiber selected from the group consisting of hemicelluloses, gums, pentosans, glucans, mucilages and pectin.

4. The product of claim 3 wherein said dietary fiber comprises beta glucan.

5. The product of claim 4 wherein said beta-glucan is obtained from oats, barley or psyllium husk.

6. The product of claim 1 wherein said core comprises sweetener in a crystalline, granular or dried syrup form.

7. The product of claim 1 wherein said core comprises refined sucrose.

8. The product of claim 1 wherein said core consists essentially of refined sucrose.

9. The product of claim 1 wherein said core comprises molasses in solid form.

10. The product of claim 1 wherein said sweetener comprises a naturally-occurring sugar.

11. The product of claim 1 wherein said sweetener comprises an artificial sweetener.

12. The product of claim 1 wherein said core comprises a single sweetener crystal, granule or particle.

13. The product of claim 1 wherein said core comprises two or more sweetener crystals, granules or particles.

14. The product of claim 1 wherein said dietary fiber is obtained from a natural source including a plant, an animal, a bacterium, a fungus or a yeast.

15. The product of claim 1 wherein said dietary fiber is obtained from a genetically manipulated plant.

16. The product of claim 1 wherein said dietary fiber is obtained through chemical modification of a carbohydrate.

17. The product of claim 1 wherein said dietary fiber is obtained from two or more different sources.

18. The product of claim 1 wherein said dietary fiber is a by-product of a food processing procedure.

19. The product of claim 1 which further comprises an edible anti-oxidant agent.

20. The product of claim 19 wherein said anti-oxidant agent is obtained from a plant source.

21. The product of claim 19 wherein said anti-oxidant is selected from a carotenoid, a phenolic compound, an anthocyanin, a flavonoid, an amino acid or a lipoic acid.

22. The product of claim 20 wherein said plant is a vegetable, legume, fruit, grain, nut or leaf.

23. The product of claim 19 wherein said product's total Oxygen Radical Absorption Capacity is not less than 1 ORAC unit.

24. The product of claim 1 further comprising an amount of an agent selected from: at least 0.02 mg thiamine/1000 kjoul; at least 0.03 mg riboflavin/1000 kjoul; at least 0.04 mg niacin/1000 kjoul; and at least 5 mg calcium/g of total dietary fiber content.

25. The product of claim 24 wherein one or more of said thiamine, riboflavin, niacin and calcium is naturally present in a plant extract from which said dietary fiber is derived.

26. The product of claim 1 which has a total lipid content of less than 2% by weight of its total solid content.

27. The product of claim 1 further comprising an additional component selected from the group consisting of insoluble dietary fibers, phytonutrients, minerals, amino acids, enzymes, vitamins or vitamin precursors, antioxidants, sugar alcohols, maltodextrin, monosaccharides and disaccharides.

28. The product of claim 27 wherein said vitamin is selected from the group consisting of vitamins A, D, E, K, C,. B6, B12, biotin, folate and pantothenic acid

29. The product of claim 1 further comprising an agent selected from PABA, inositol and choline.

30. The product of claim 1, further comprising a mineral selected from the group consisting of phosphorus, sodium, potassium, magnesium, manganese, zinc, iron, copper, iodine, selenium and chromium.

31. The product of claim 27 wherein said sugar alcohol is sorbitol.

32. The product of claim 27 wherein said phytonutrient is selected from carotenoids, flavonoids or polyphenols, isoflavones, inositol phosphates or phytates, lignans or phytoestrogens, isothiocyanates and indoles, phenols, saponins, sulfides and thiols, and terpenes.

33. The product of claim 1 further comprising an additional component selected from the group consisting of pH indicators, coloring agents and aromatic agents.

34. The product of claim 1 wherein said shell composition is applied to the core composition by wet or dry coating of the shell composition onto the wet or dry core composition.

35. A method of sweetening solid or liquid food, the method comprising adding a product of claim 1 to said food.

36. A method of sweetening food wherein all or a portion of the sucrose normally found in said food is substituted with a product of claim 1.

37. A food sweetening product of manufacture comprising a core comprising sucrose encapsulated in a shell comprising dietary fiber.

38. The product of claim 37 wherein the total dietary fiber content of said product is at least 1% by weight relative to the sucrose content.

39. The product of claim 37 wherein said dietary fiber comprises a fiber selected from the group consisting of hemicelluloses, gums, pentosans, glucans, mucilages and pectin.

40. The product of claim 39 wherein said dietary fiber comprises beta glucan.

41. The product of claim 39 wherein said core comprises sucrose in a crystalline, granular or dried syrup form.

42. The product of claim 39 wherein said core consists essentially of sucrose in a cystalline, granular or dried syrup form.

43. The product of claim 39 wherein said core comprises a single sucrose crystal, granule or particle.

44. The product of claim 39 wherein said core comprises two or more sucrose crystals, granules or particles.

45. The product of claim 39 further comprising an amount of an agent selected from: at least 0.02 mg thiamine/1000 kjoul; at least 0.03 mg riboflavin/1000 kjoul; at least 0.04 mg niacin/1000 kjoul; and at least 5 mg calcium/g of total dietary fiber content.

46. The product of claim 45 wherein one or more of said thiamine, riboflavin, niacin and calcium is naturally present in a plant extract from which said dietary fiber is derived.

47. The product of claim 39 further comprising an additional component selected from the group consisting of insoluble dietary fibers, phytonutrients, minerals, amino acids, enzymes, vitamins or vitamin precursors, antioxidants, sugar alcohols, maltodextrin, monosaccharides and disaccharides.

48. The product of claim 39, further comprising an artificial sweetener.

49. The product of claim 48 wherein said artificial sweetener comprises aspartame, saacharin or sucralose.

50. The product of claim 39 wherein said shell composition is applied to the core composition by wet or dry coating of the shell composition onto the wet or dry core composition.

51. A method of sweetening solid or liquid food, the method comprising adding a product of claim 39 to said food.

52. A method of sweetening food wherein all or a portion of the sucrose normally found in said food is substituted with a product of claim 39.

53. A food sweetening product of manufacture comprising a core comprising dextrose or corn sugar encapsulated in a shell comprising dietary fiber.
